(19) United States
(12) Patent Application Publication
(10) Pub. No.: US 2018/0353370 A1
(43) Pub. Date: Dec. 13, 2018

(54) Assembled Exercise Device and Assembly Unit Thereof

(71) Applicant: Ping-Feng Liao, Changhua City (TW)

(72) Inventor: Ping-Feng Liao, Changhua City (TW)

(21) Appl. No.: 15/997,741

(22) Filed: Jun. 5, 2018

(30) Foreign Application Priority Data
Jun. 9, 2017 (TW) 106208371

(51) Int. Cl. A61H 15/00

(52) U.S. Cl. CPC A61H 15/0092; A61H 2015/0021; A61H 2201/1645; A61H 2201/0192; A61H 2201/0107

(57) ABSTRACT

An assembled exercise device is provided and includes two or more detachable assembly units, the two assembly units are adjacent and combined to each other by their plug structure and socket structure, each assembly unit has an inner tube and one or more foam rings surrounded thereon, the edge of the inner tube forms a flange, so that the foam rings surrounding on each assembly unit can be positioned between two flanges, each of the outermost assembly units is assembled with a tube cap; while practicing the present invention, the length can be adjusted by changing the number of the assembly units, and the overall diameter can be adjusted as well by selecting the foam rings having different diameters to be used, so as to be applied to users with different body types. In addition, the inner space formed by the connected assembly units can be utilized for storing stuffs such as bottle waters or towels, thereby enhancing the convenience.

### FIELD OF THE INVENTION

The present invention relates to an exercise device, and more particularly to an assembled exercise device and the assembly unit thereof.

### BACKGROUND OF THE INVENTION

While it is needed to relax after fitness exercises, a fitness roller covered by foam is commonly used for such relaxation. While in use, the fitness roller is placed on the floor, and then the body portion that intends to be massaged can be placed on the fitness roller. By slowly rolling back and forth along with the fitness roller, and with the body weight borne on the portions to be massage with the fitness roller, the muscles and fascia can be thereby relaxed.

When using the fitness roller to relax after exercises, muscles can be stretched to allow deep relaxation. In order to enhance the effect of massage, multiple protrusions can be formed on the surrounding foam of some fitness rollers; when the user is in a plank posture and with the elbow placed on the floor, the fitness roller can also be placed under user's ankles preventing the tiptoe touching the floor during training, so that the back of the body, namely from the head to the foot, can be kept in a straight line, thereby strengthening the body core muscles with the roller staying still.

Although the existing fitness roller mentioned above can be used to relax the muscles, the foam surrounding the roller is an integrally formed structure, the diameter or the length as well as the shape are fixed and not able to be adjusted, thereby failing to be customized in order to meet with various needs of users having different body types. The positions of the protrusions formed around the foams cannot be adjusted as well. Accordingly, the existing fitness rollers still have room for improvement in order to solve the aforementioned existing problems.

### SUMMARY OF THE INVENTION

Since the length and diameter of the existing fitness rollers cannot be changed, it is limited to be applied to different users with different body types. As a result, a new type of exercise device is provided by assembling a number of assembly units, so as to make the length and the diameter of fitness rollers to be adjustable through structural adjustments and/or replacements, making this assembled exercise device suitable for users of all body types. Moreover, the assembled exercise device can also be interoperable with handle/hand grip accessories.

To achieve the above-mentioned objective, an assembled exercise device is provided and includes:

at least two assembly units subsequently assembled in a left-right direction, each of the assembly units having an inner tube and one or more foam rings, each of the inner tubes having a tubular body extending in the left-right direction, a left end of an outer peripheral surface of each tubular body having a ring-shaped flange formed thereon, a right end of an inner surface of each tubular body having a ring-shaped protruding portion extending outwardly, each protruding portion being a plug structure, a left end of the inner surface forming a socket structure, wherein two adjacent assembly units are capable of being assembled by connecting the plug structure of one of the two assembly units positioned at the left side, with the socket structure of the other assembly unit positioned at the right side, each of the one or more foam rings has a through-hole in order to sheath around the outer periphery of the tubular body of the corresponding assembly unit; and

a first tube cap having a cap body, an inner surface of the cap body forming the socket structure, wherein the first tube cap is capable of being assembled with the rightmost assembly unit by connecting the socket structure of the first tube cap with the plug structure of the rightmost assembly unit, the cap body has an opening, the peripheral edge of the opening is extended outwardly to form a positioning ring, the one or more foam rings assembled with the rightmost assembly unit is positioned between the positioning ring and the flange of the rightmost assembly unit.

By utilizing the unitized structure of an assembly unit that contains an inner tube and one or more foam rings, and by consecutively combining two or more such assembly units in the left-right direction, a roller-type exercise device can be formed for exercising use.

The effect offered by the present invention is that, when the user intends to adjust the length of the present invention, and since the assembly unit is a consecutively assemblable structure, the length of the exercise device can be freely adjusted by changing the number of the assembly units connected in the left-right direction. Additionally, because each of the foam rings surrounding each assembly unit is a replaceable structure, when the user intends to adjust the radial width of the exercise device, the foam rings can be replaced with one having desired diameters. The assembled exercise device can be not only assembled having the same overall diameter, but also assembled into an fitness roller in a hourglass shape, i.e. having the smallest diameter at the middle of the structure with gradually increased diameters from the middle to the sides in a symmetrical manner, so as to be used in sculpturing body curves, or with users having different body types.

According to an embodiment of the present invention, the assembled exercise device further includes a first tube cap and a second tube cap respectively capped on the rightmost assembly unit and the leftmost assembly unit, so as to form an inner space for storage of various stuffs. Besides, hand grips can be formed with the first tube cap and the second tube cap to provide an additional function of self-massaging, thereby expanding the usage and enhancing the convenience of the present invention.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a perspective view illustrating a first preferred embodiment of the present invention;

FIG. 2 is an exploded view illustrating the first preferred embodiment of the present invention;

FIG. 3 is a partially exploded view illustrating the first preferred embodiment of the present invention;

FIG. 4 is a partial cross-sectional view illustrating the first preferred embodiment of the present invention;

FIG. 5a, 5b are schematic drawings illustrating the adjustment of the rotation angle of the foam ring according to the first preferred embodiment of the present invention;

FIG. 6 is a perspective view illustrating a second preferred embodiment of the present invention;

FIG. 7 is a cross-sectional view illustrating the second preferred embodiment of the present invention;

FIG. 8 is a perspective view illustrating a third preferred embodiment of the present invention;

FIG. 9 is a cross-sectional view illustrating the third preferred embodiment of the present invention;

FIG. 10 is a perspective view illustrating a fourth preferred embodiment of the present invention; and

FIG. 11 is a cross-sectional view illustrating the fourth preferred embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the device by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that when an element is referred to as being “connected” to another element, it can be directly connected to the other element or intervening elements may be present.

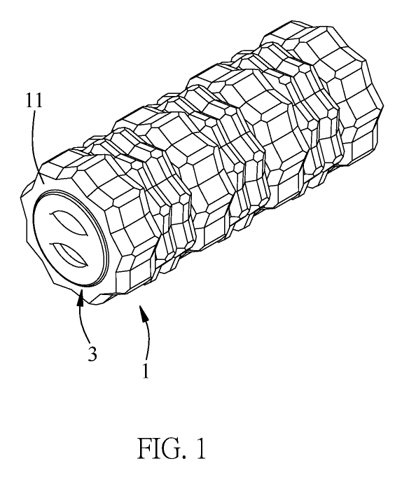

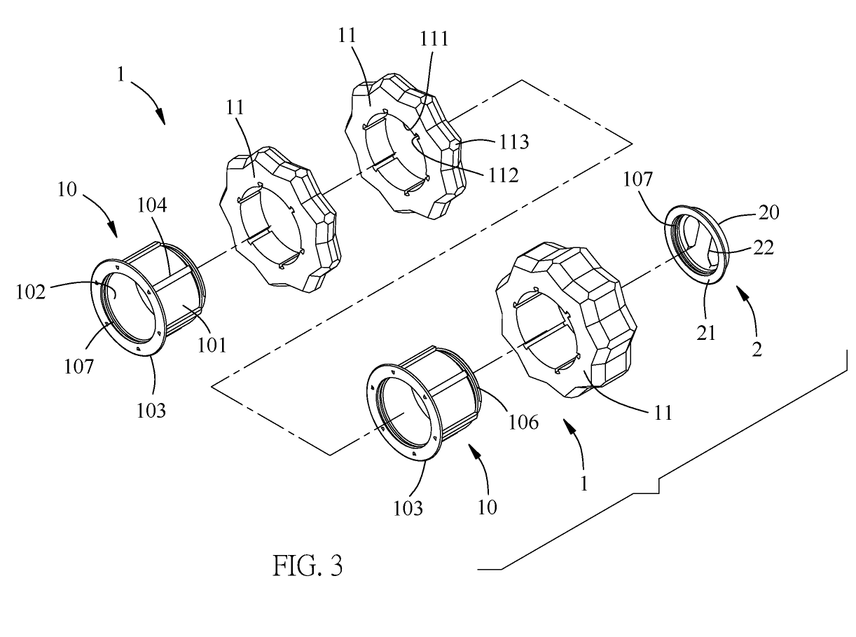

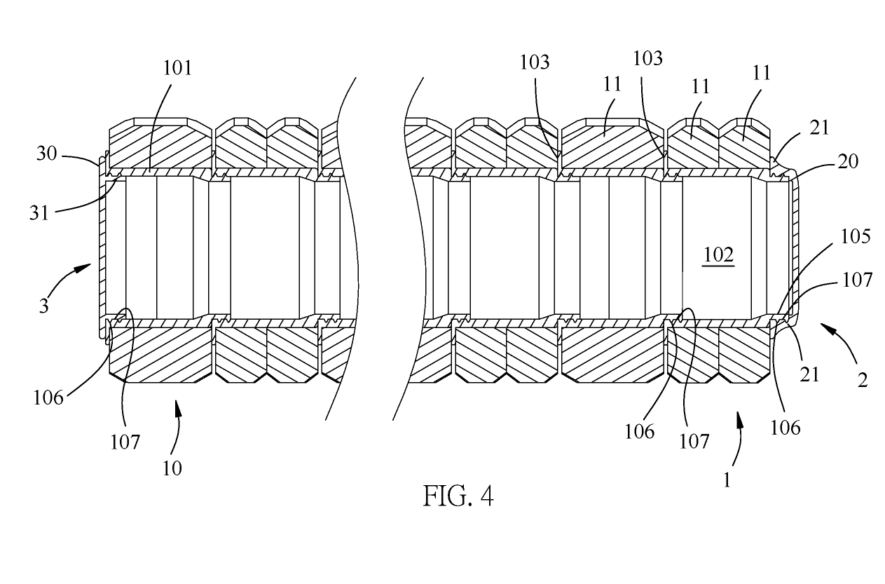

Referring to FIG. 1 to FIG. 4 illustrating a first preferred embodiment of the present invention, a roller-type assembled exercise device is provided, including two or more consecutively assembled assembly units 1 in a left-right direction, a first tube cap 2 assembled with the rightmost assembly unit 1, and a second tube cap 3 assembled with the leftmost assembly unit 1.

According to the present preferred embodiment, seven consecutive assembly units 1 are assembled in the left-right direction, where each of the assembly units 1 has an inner tube 10 and one or more foam rings 11 circumferentially sheathing the inner tube 10. Each of the inner tubes 10 has a tubular body 101 being in a cylindrical-shape having a central axis extending in the left-right direction. A hollow cavity 102 is defined inside each of the tubular bodies 101. A left side of the outer surface of each tubular body 101 forms a ring-shaped flange 103. Six equally-spaced ribs 104 are arranged around the outer surface of each tubular body 101, in which each of the six ribs 104 is in a straight-line shape extending along the direction as the central axis 101 of the tubular body 101. A right end of the inner surface of each tubular body 101 has a ring-shaped protruding portion 105 extending outwardly, and each protruding portion 105 includes a plug structure 106. The plug structure 106 in the present embodiment is a screw thread formed at the outer surface of the protruding portion 105. A left end of the inner surface of each tubular body 101 forms a socket structure 107 corresponding to the shape of the plug structure 106. According to the present preferred embodiment, the socket structure 107 is a screw hole that can be assembled with the plug structure 106 of another inner tube 10.

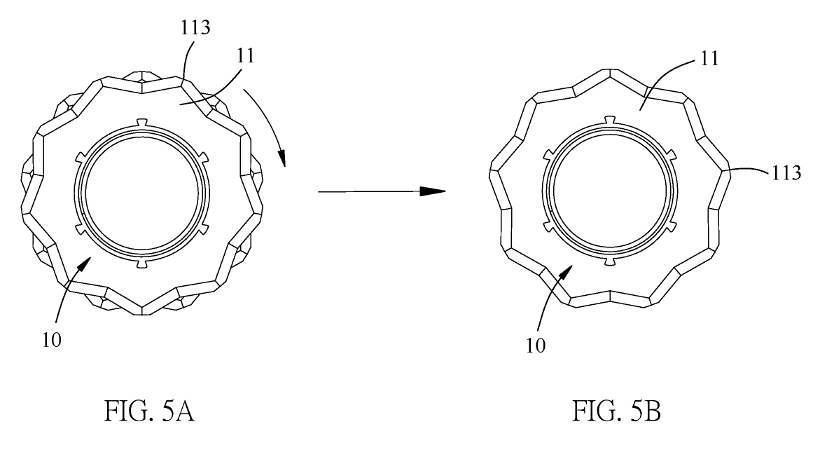

The number of the foam rings 11 sheathing around each inner tube 10 is one or two according to the present preferred embodiment. The total left-right width of the foam rings 11 arranged on each inner tube 10 in the left-right direction equals to the left-right width of the tubular body 101 of the inner tube 10, and the leftmost foam ring 11 abuts against the flange 103 of the corresponding inner tube 10. Each of the foam rings 11 has a round through-hole 111 for sheathing around the tubular body 101 of the corresponding inner tube 10. Six equally-spaced grooves 112 are formed around an inner surface of each foam ring 11 that defines the periphery of each through-hole 111, in which each of the grooves 112 corresponds to each of the ribs 104 arranged around the outer surface of the corresponding inner tube 10. Each of the grooves 112 is a straight-lined groove extending through the foam ring 11 in the left-right direction, and the six ribs 104 are respectively inserted into the six grooves 112. A number of bumping portions 113 are formed along the peripheral surface of each foam ring 11; in the present instance, nine equally-spaced bumping portions 113 are formed around each foam ring 11. While the assembly units 1 are disassembled and separated from each other, each foam ring 11 can be sliding along the corresponding inner tube 10 in the left-right direction. As shown in FIG. 5a to FIG. 5b, while each foam ring 11 has been removed from the corresponding inner tube 10, the foams rings 11 can be reassembled with their inner tubes 10 after a 60-degree self-rotation or its multiples, the bumping portions 113 of adjacent foam rings 11 can thereby be turned and adjusted to be aligned or alternately arranged.

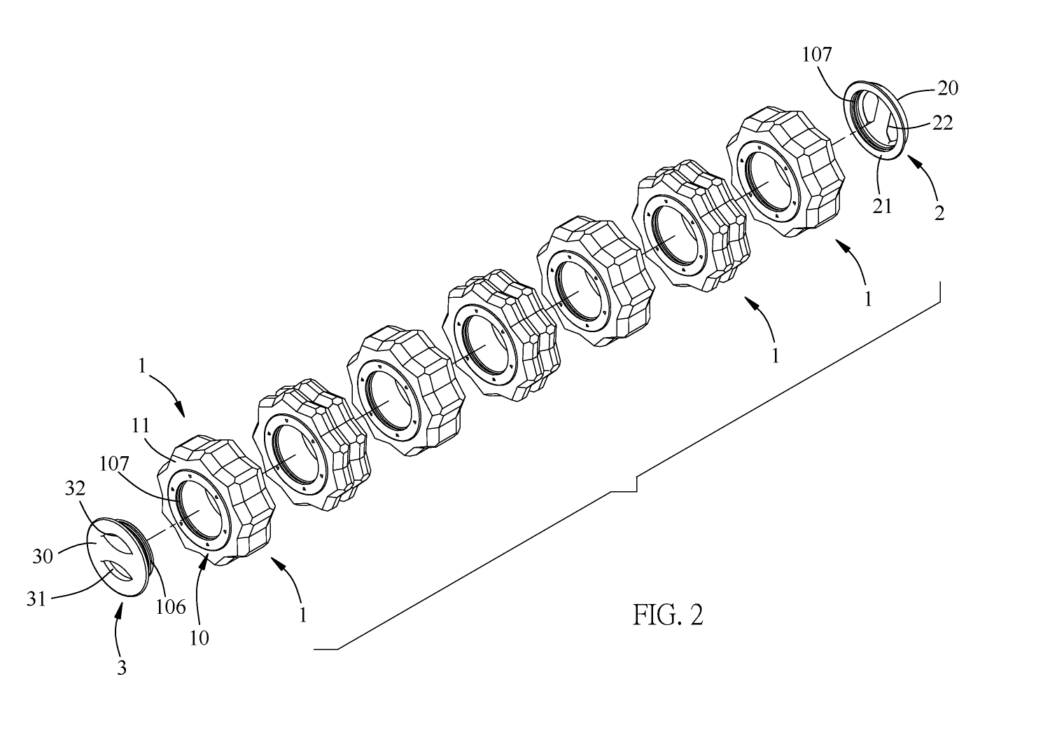

While assembling two adjacent assembly units 1, as shown in FIG. 2 to FIG. 4, the plug structure 106 of the inner tube 10 located at the left is assembled with the socket structure 107 of the inner tube 10 located at the right. Taking the present preferred embodiment as an example, the plug structure 106 of the assembly unit 1 located at the left is screwed into the socket structure 107 of another assembly unit 1 located at the right, so that the two foam rings 11 of the left assembly unit can be positioned between the flange 103 of the left inner tube 10 and the flange 103 of the right inner tube 10. In addition, because the diameters of each foam ring 11 of the assembly units 1 in the present preferred embodiment are the same, the seven assembly units 1 can be transformed into a massage roller after combining together. It is worth mentioning that, in order to enhance the massage effect, the bumping portions 113 between two adjacent assembly units 1 can be alternately arranged.

The first tube cap 2 has a round cap body 20, socket structures 107 can be formed on an inner surface of the cap body 20, and can be screw holes according to the present preferred embodiment. The cap body 20 can be assembled with the rightmost assembly unit 1 by connecting the socket structures 107 of the cap body 20 with the plug structures 106 of the rightmost assembly unit 1. The cap body 20 has an opening, the peripheral edge of the opening is extended outwardly to form a positioning ring 21, the foam ring 11 of the rightmost assembly unit can be positioned between the positioning ring 21 of the cap body 20 and the flange 103 of the rightmost assembly unit 1. The first tube cap 2 is capped on the right end of the seven connected hollow cavities 102 of the seven assembly units 1. The cap body 20 has a pair of first carrying holes 22 penetrating through.

The second tube cap 3 has a round cover plate 30 having a protruding surface forming a fastening ring 31 that includes plug structures 106. The plug structures 106 in the present embodiment are screw threads formed at the outer surface of the fastening ring 31. The second tube cap 3 is capped on the left end of the seven connected hollow cavities 102 of the seven assembly units 1. The cover plate 30 has a pair of second carrying holes 23 penetrating through.

While using the assembled exercise device of the aforementioned preferred embodiment to exercise, the assembled exercise device can be placed on the floor, so that the body parts to be massaged are in contact with a part of or all the foam rings 11 of the assembly units 1; by moving back and forth with a part of or all the assembly units 1, the body parts to be massaged can be pressed with the bumping portions 113 of the foam rings 11 naturally by the body weight, thereby relaxing the muscles and fascia. The present invention is also capable of storing things, for instance, while all the assembly units 1 are assembled, the hollow cavities 102 form a channel that can store bottle water or towel. The present invention is also fully portable, it can be easily hand-carried by a user by the first carrying holes 22 of the first tube cap 2 or the second carrying holes 23 of the second tube cap.

In addition to the aforementioned preferred embodiment which has six ribs 104 formed around the inner tube 10 of the assembly unit 1, the number of ribs 104 may also be only one formed at the peripheral surface of the tubular body 101 of the inner tube 10, or, alternatively, the number of ribs 104 may be two, three, or even eight, where all these ribs 104 are all equally-spaced around the tubular body 101. The number and location of the grooves 112 may also be adjusted in correspondence with the ribs 104. While the number of the ribs 104 arranged around the inner tube 10 increases, the adjustable rotation angle of the foam ring 11 for re-assembling after removing from the inner tube becomes smaller, so that the position of the bumping portions 113 of the foam rings 11 can be adjusted more precisely by removing, rotating, and re-assembling the foam rings 11, in order to meet with various user demand of massaging. Besides, in addition to the instance that the plug structures 106 and the socket structures 107 are screw threads and screw holes forming a detachable structure, they may also by other types of detachable structures such as buckles and buckle holes, or protrusions and recesses corresponding to each other.

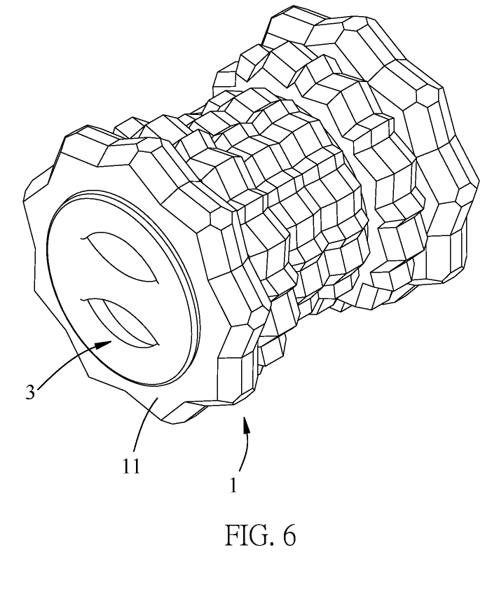

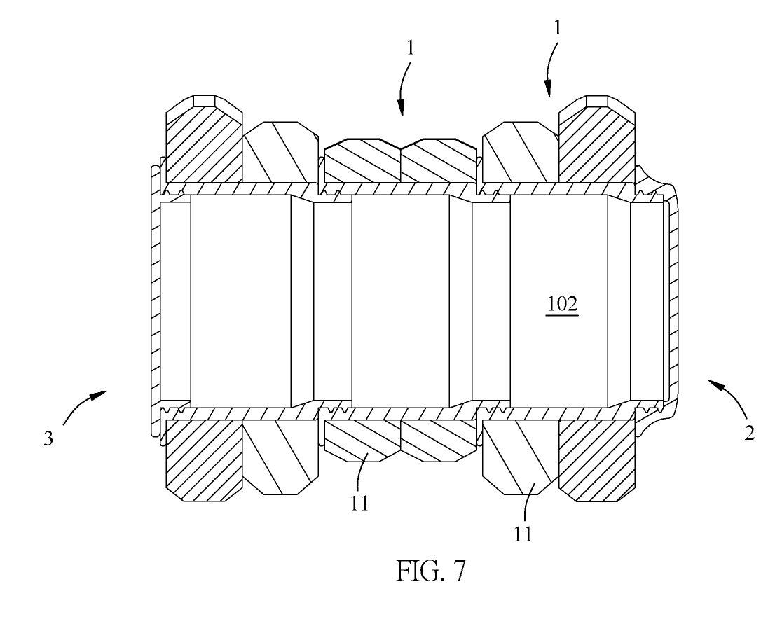

The total left-right length of the present invention can also be adjusted upon user needs and can be changed by removing or adding the number of the assembly units 1; additionally, if the user has needs to adjust the width of the prevent invention, i.e. the length perpendicular to the left-right direction, different types of foam rings 11 having different diameters can be chosen to be assembled with the inner tube 10 of the assembly unit 1. For instance, referring to FIG. 6 and FIG. 7 illustrating another preferred embodiment of the present invention, the number of the assembly units 1 assembled in the left-right direction can be changed into three, in which the first tube cap 2 and the second tube cap 3 are also respectively connected to the rightmost assembly unit 1 and the leftmost assembly unit 1, the foam ring 11 assembled on the central assembly unit 1 has been changed to a smaller one, and the diameters of the foam rings 11 of the assembly units 1 on the left and right side of the central assembly unit 1 gradually increases in a symmetrical manner, thereby forming an hourglass-shaped roller capable of sculpturing body curves.

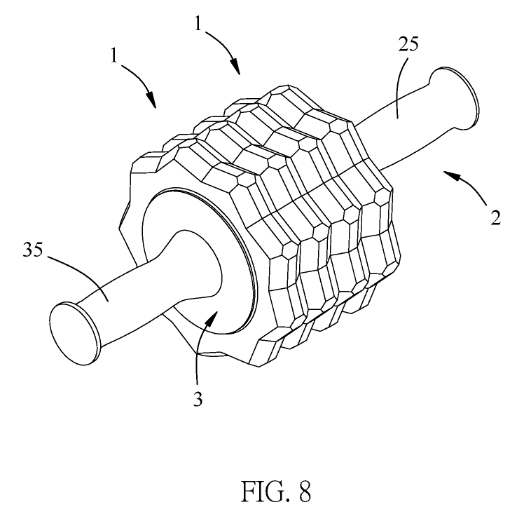

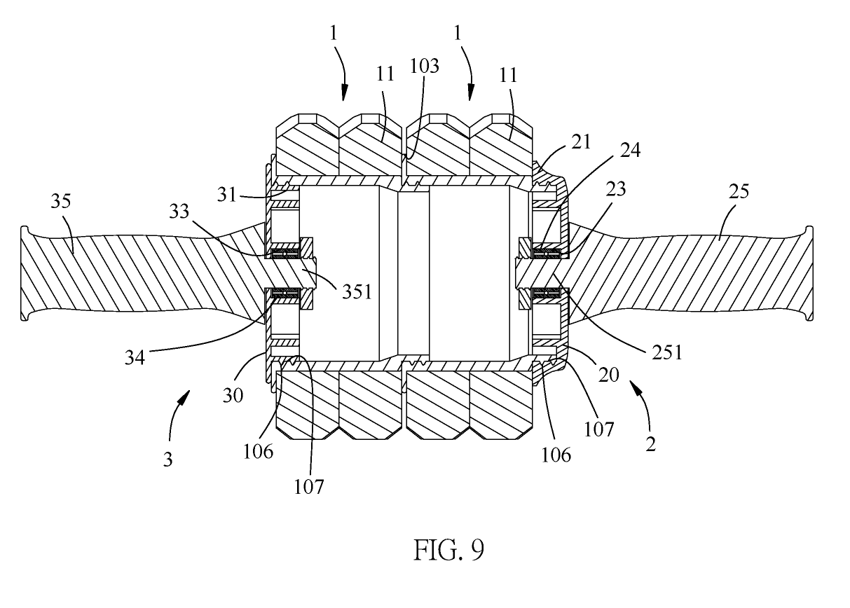

The aforementioned embodiments are to assemble the right end and the left end of the assembly unit 1 with the first tube cap 2 and the second tube cap 3. By capping the right end and the left end of the connected hollow cavities 102 with the first tube cap 2 and the second tube cap 3, articles can be stored inside the inner space of the connected hollow cavities 102. The third preferred embodiment below shown in FIG. 8 and FIG. 9 provides an assembled exercise device having alternative functions by adjusting the structures of the first tube cap 2 and the second tube cap 3.

In reference with FIG. 8 and FIG. 9, the third preferred embodiment of the present invention is to provide an assembled exercise device in a hand-grip roller type including two assembly units 1 connected in the left-right direction, where the structures of the two assembly units 1 are identical with the aforementioned embodiments, and the plug structure 106 of the right assembly unit 1 is screwed with a first tube cap 2, and socket structure 107 of the left assembly unit 1 is screwed with a second tube cap 3.

The first tube cap 2 has a round cap body 20, an inner surface of the cap body 20 forms a socket structure 107, the socket structure 107 of the present preferred embodiment is a screw hole, the cap body 20 is connected to the right assembly unit 1 by screwing the socket structure 107 with the plug structure 106 of the right assembly unit 1, the cap body 20 has an opening, the peripheral edge of the opening is extended outwardly to form a positioning ring 21, the foam ring 11 of the right assembly unit 1 is positioned between its flange 103 and the positioning ring 21. A first bearing hole 23 is formed at the center of the cap body 20, a first bearing 24 is embedded in the first bearing hole 23, a first hand grip 25 is assembled corresponding to the first bearing 24, the assembling direction of the first hand grip 25 is the same as the direction where the center axis of each assembly unit 1 extends, the first hand grip 25 has a first shaft 251 protruding from a rotation axis of the first hand grip 25, and the first shaft 251 is inserted and positioned into the first bearing 24.

The second tube cap 3 has a round cover plate 30, an inner surface of the cover plate 30 protrudes to form a fastening ring 31, the fastening ring 31 includes a plug structure 106, the plug structure 106 of the present preferred embodiment is a screw thread at the outer surface of the fastening ring 31, the cover plate 30 is connected to the left assembly unit 1 by screwing the plug structure 106 with the socket structure 107 of the left assembly unit 1. A second bearing hole 33 is formed at the center of the cover plate 30, a second bearing 34 is embedded in the second bearing hole 33, a second hand grip 35 is assembled corresponding to the second bearing 34, the assembling direction of the second hand grip 35 is the same as the direction where the center axis of each assembly unit 1 extends, the second hand grip 35 has a second shaft 351 protruding from a rotation axis of the second hand grip 35, and the second shaft 351 is inserted and positioned into the second bearing 34.

While in use of the third preferred embodiment, the first hand grip 25 and the second hand grip 35 can be held by the user's hands, and the foam rings 11 positioned between the cap body 20 and the cover plate 30 of the two assembly units 1 can be pressed against the user's body to perform massage. Because of the first bearing 24 positioned between the first shaft 251 of the first hand grip 25 and the cap body 20, and the second bearing 34 positioned between the second shaft 351 of the second hand grip 35 and the cover plate 30, the two assembly units 1 as well as their foam rings 11 can be rotated relative to the first hand grip 25 and the second hand grip 35, thereby performing massage to the body by rolling. The number of the assembly units 1 illustrated in the present third preferred embodiment is not limited to two, for instance, it can also be one, three or four upon practical needs.

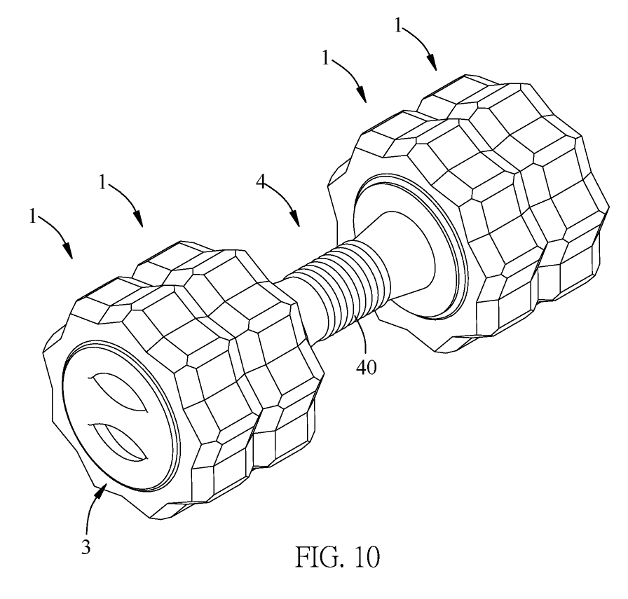

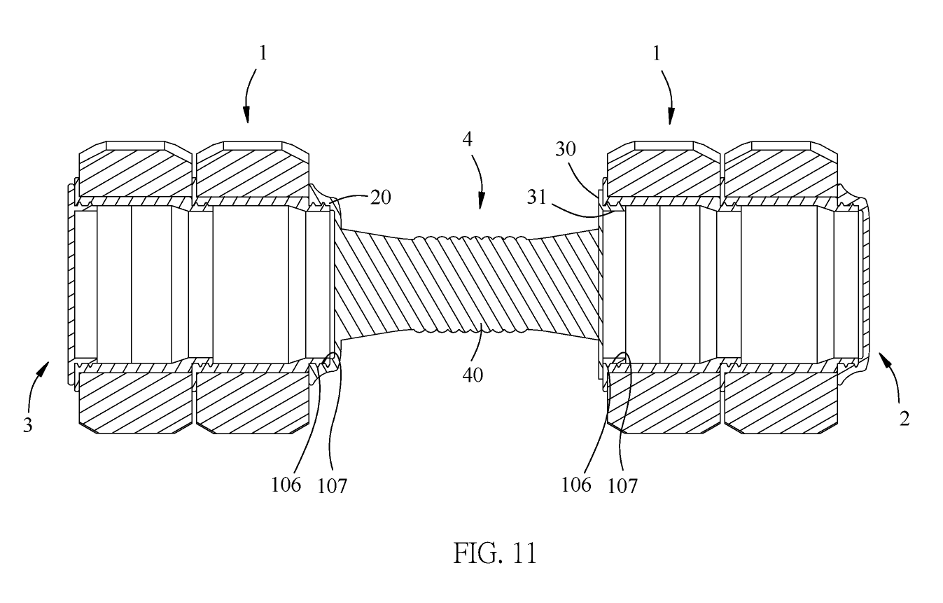

In addition to the aforementioned embodiments which illustrate roller-type exercise devices that include combinations of assembly units 1 in the left-right direction, another type of assembled exercise device is also provided. FIG. 10 and FIG. 11 illustrate the fourth preferred embodiment of the present invention, two sets of assembly units 1 are used and assembled to form a water dumbbell-type of exercise device.

In reference with FIG. 10 and FIG. 11, the assembled exercise device of the fourth preferred embodiment is provided including a first set of assembly units 1 and a second set of assembly units 1 located at the right side and the left side, respectively, and being left-right symmetrical to each other. Each set of assembly units 1 contains two left-right assembled assembly units 1. The assembly manner and structures of the two assembly units 1 contained in the first set of assembly units 1 are identical with the first preferred embodiment, but without the second tube cap 3 assembled with the left assembly unit 1. Similarly, the assembly manner and structures of the two assembly units 1 contained in the second set of assembly units 1 are identical with the second preferred embodiment, but without the first tube cap 2 assembled with the right assembly unit 1.

A hand grip unit 4 is disposed between the first set of assembly units 1 and the second set of assembly units 1, the hand grip unit 4 has a hand grip 40, the hand grip 40 is a rod extending in the left-right direction, a cover plate 30 is formed at the right end of the hand grip 40, the cover plate 30 is a round plate concentric with the hand grip 40, the diameter of the cover plate 30 is larger than the diameter of the hand grip 40, a fastening ring 31 is formed at a protruding portion of a surface of the cover plate 30, where the fastening ring 31 is concentric with the cover plate 30. The fastening ring 31 includes a plug structure 106, the plug structure 106 of the present preferred embodiment is a screw thread formed around the outer periphery of the fastening ring 31, the hand grip unit 4 is assembled with the first set of assembly units 1 by screwing the plug structure 106 of the first set of assembly units 1 to the socket structure 107 of the left assembly unit 1 within the first set of assembly units 1; a cap body 20 is formed at the left end of the hand grip 40, the cap body 20 is a round plate concentric with the hand grip 40, the diameter of the cap body 20 is larger than the diameter of the hand grip 40, a socket structure 107 is formed circumferentially at the inner surface of the cap body 20. The socket structure 107 of the present preferred embodiment is a screw hole, the hand grip unit 4 is assembled with the second set of assembly units 1 by screwing the socket structure 107 of the second set of assembly units 1 with the plug structure 106 of the right assembly unit 1 within the second set of assembly units 1.

In addition of the fourth preferred embodiment of the present invention which includes a combination of the first set of assembly units 1 and the second set of assembly units 1 which respectively contain two assembly units 1 being assembled to each other in the left-right direction, each set of assembly units may also contain only one assembly unit 1, or, alternatively, contain three or more consecutively assembled assembly units 1 in the left-right direction, meaning that the number of the assembly units 1 used can be freely chosen upon user needs.

The description of the invention including its applications and advantages as set forth herein is illustrative and is not intended to limit the scope of the invention, which is set forth in the claims variations and modifications of the embodiments disclosed herein are possible, and practical alternatives to and equivalents of the various elements of the embodiments would be understood to those of ordinary skill in the art upon study of this patent document. For example, specific values given herein are illustrative unless identified as being otherwise, and may be varied as a matter of design consideration. Terms such as “target” and “background” or so are distinguishing terms and are not to be construed to imply an order or a specific part of the whole. These and other variations and modifications of the embodiments disclosed herein, including of the alternatives and equivalents of the various elements of the embodiments, may be made without departing from the scope and spirit of the invention, including the invention as set forth in the following claims.

What is claimed is:

1. An assembled exercise device, comprising:
at least two assembly units subsequently assembled in a left-right direction, each of the assembly units having an inner tube and one or more foam rings, each of the inner tubes having a tubular body extending in the left-right direction, a left end of an outer peripheral surface of each tubular body having a ring-shaped flange formed thereon, a right end of an inner surface of each tubular body having a ring-shaped protruding portion extending outwardly, each protruding portion being a plug structure, a left end of the inner surface forming a socket structure, wherein two adjacent assembly units are capable of being assembled by connecting the plug structure of one of the two assembly units positioned at the left side, with the socket structure of the other assembly unit positioned at the right side, each of the one or more foam rings has a through-hole in order to sheath around the outer periphery of the tubular body of the corresponding assembly unit; and
a first tube cap having a cap body, an inner surface of the cap body forming the socket structure, wherein the first tube cap is capable of being assembled with the rightmost assembly unit by connecting the socket structure of the first tube cap with the plug structure of the rightmost assembly unit, the cap body has an opening, the peripheral edge of the opening is extended outwardly to form a positioning ring, the one or more foam rings assembled with the rightmost assembly unit is positioned between the positioning ring and the flange of the rightmost assembly unit.

2. The assembled exercise device as claim in claim 1, wherein each of the plug structures is a screw plug, and each of the socket structures is a screw hole.

3. The assembled exercise device as claimed in claim 1, wherein the leftmost assembly unit is capable of being assembled with a second tube cap, the second tube cap has a cover plate having a protruding surface forming a fastening ring that forms the plug structure, the second tube cap is capable of being assembled with the leftmost assembly unit by fastening the plug structure to the socket structure of the leftmost assembly unit.

4. The assembled exercise device as claimed in claim 3, wherein the center of the cap body of the first tube cap has a pair of first carrying holes penetrating therethrough, the center of the cover plate of the second tube cap has a pair of second carrying holes penetrating therethrough.

5. The assembled exercise device as claimed in claim 3, wherein a first bearing hole is formed at the center of the cap body of the first tube cap and has a first bearing embedded therein, a first hand grip is assembled corresponding to the first bearing, the first hand grip has a first shaft protruding from a rotation axis of the first hand grip, the first shaft is inserted and positioned into the first bearing, a second bearing hole is formed at the center of the cover plate of the second tube cap and has a second bearing embedded therein, a second hand grip is assembled corresponding to the second bearing, the second hand grip has a second shaft protruding from a rotation axis of the second hand grip, the second shaft is inserted and positioned into the second bearing.

6. The assembled exercise device as claim in claim 3, wherein each of the plug structures is a screw plug, and each of the socket structures is a screw hole.

7. The assembled exercise device as claimed in claim 3, wherein each of the tubular bodies is cylindrically-shaped and has a plurality of equally-spaced ribs formed around the outer periphery of the tubular body, each of the ribs is in a straight-line shape and extending in the left-right direction; each through-hole of each foam ring is a round hole, a plurality of equally-spaced grooves are formed around an inner surface of the through-hole, each of the plurality of grooves corresponds to each of the plurality of ribs and is a straight-lined groove extending through the foam ring in the left-right direction, each rib is capable of being inserted into each groove.

8. The assembled exercise device as claimed in claim 7, wherein the center of the cap body of the first tube cap has a pair of first carrying holes penetrating therethrough, the center of the cover plate of the second tube cap has a pair of second carrying holes penetrating therethrough.

9. The assembled exercise device as claimed in claim 7, wherein a first bearing hole is formed at the center of the cap body of the first tube cap and has a first bearing embedded therein, a first hand grip is assembled corresponding to the first bearing, the first hand grip has a first shaft protruding from a rotation axis of the first hand grip, the first shaft is inserted and positioned into the first bearing, a second bearing hole is formed at the center of the cover plate of the second tube cap and has a second bearing embedded therein, a second hand grip is assembled corresponding to the second bearing, the second hand grip has a second shaft protruding from a rotation axis of the second hand grip, the second shaft is inserted and positioned into the second bearing.

10. The assembled exercise device as claim in claim 7, wherein each of the plug structures is a screw plug, and each of the socket structures is a screw hole.

11. An assembled exercise device, comprising:
two sets of assembly units adjacent to each other in a left-right direction, each set of assembly units including two or more subsequently assembled assembly units in the left-right direction, each of the assembly units having an inner tube and one or more foam rings, each of the inner tubes having a tubular body extending in the left-right direction, a left end of an outer peripheral surface of each tubular body having a ring-shaped flange formed thereon, a right end of an inner surface of each tubular body having a ring-shaped protruding portion extending outwardly, each protruding portion being a plug structure, a left end of the inner surface forming a socket structure, wherein two adjacent assembly units are capable of being assembled by connecting the plug structure of one of the two assembly units positioned at the left side, with the socket structure of the other assembly unit positioned at the right side, each of the one or more foam rings has a through-hole in order to sheath around the outer periphery of the tubular body of the corresponding assembly unit; and
a first tube cap having a cap body, an inner surface of the cap body forming the socket structure, wherein the first tube cap is capable of being assembled with the set of assembly units located at the right by connecting the socket structure of the first tube cap with the plug structure of the rightmost assembly unit, the cap body has an opening, the peripheral edge of the opening is extended outwardly to form a positioning ring, the one or more foam rings assembled with the rightmost assembly unit is positioned between the positioning ring and the flange of the assembly unit; and
a hand grip unit, having a hand grip, a cover plate formed at a right end of the hand grip and having a protruding surface forming a fastening ring that forms the plug structure, the hand grip unit capable of being assembled with the leftmost assembly unit in the right set of assembly units by fastening the plug structure to the socket structure of the leftmost assembly unit in the right set of assembly units; the cap body formed at a left end of the hand grip, an inner surface of the cap body forming the socket structure, wherein the hand grip unit is capable of being assembled with the rightmost assembly unit in the left set of assembly units by connecting the socket structure of the hand grip unit with the plug structure of the rightmost assembly unit in the left set of assembly units.

12. The assembled exercise device as claimed in claim 11, wherein each of the plug structures is a screw plug, and each of the socket structures is a screw hole.

13. An assembly unit of an assembled exercise device, comprising an inner tube and one or more foam rings, wherein:
the inner tube has a tubular body extending in the left-right direction, a left end of an outer peripheral surface of the tubular body has a ring-shaped flange formed thereon, a right end of an inner surface of the tubular body has a ring-shaped protruding portion extending outwardly, the protruding portion is a plug structure, a left end of the inner surface forms a socket structure corresponding to the plug structure, each of the one or more foam rings has a through-hole in order to sheath around the outer periphery of the tubular body of the corresponding assembly unit.

14. The assembled exercise device as claim in claim 13, wherein the plug structure is a screw plug, and the socket structure is a screw hole.
